(19) United States
(12) Patent Application Publication
(10) Pub. No.: US 2026/0129451 A1
(43) Pub. Date: May 7, 2026

(54) METHOD FOR A RADIO-BASED DISTANCE MEASUREMENT, FREQUENCY SYNCHRONIZATION, TIME SYNCHRONIZATION, AND A DETECTION AND/OR PREVENTION OF RELAY ATTACKS WITH A SELECTION OF THE RADIO SIGNALS TO BE USED

(71) Applicant: LAMBDA:4 ENTWICKLUNGEN GMBH, Hamburg (DE)

(72) Inventor: Rönne REIMANN, Hamburg (DE)

(73) Assignee: LAMBDA:4 ENTWICKLUNGEN GMBH, Hamburg (DE)

(21) Appl. No.: 19/110,941

(22) PCT Filed: Apr. 29, 2024
(86) PCT No.: PCT/EP2024/061779

§ 371 Date: Mar. 12, 2025

(30) Foreign Application Priority Data
Apr. 28, 2023 (WO) PCT/EP2023/061372
Feb. 5, 2024 (EP) 24155873.3
Feb. 5, 2024 (WO) PCT/EP2024/052807

(51) Int. Cl. H04W 12/122; H04W 24/10; H04W 56/00; H04W 64/00

(52) U.S. Cl. CPC H04W 12/122; H04W 24/10; H04W 56/0015; H04W 64/00

(57) ABSTRACT

A method for radio-based distance measurement and in addition also to a method for detecting and/or preventing relay attacks and a method for time and/or frequency synchronisation. The method does not require coherence information, in particular neither phase-coherent switching nor switching in such a way that the phase after switching is known relative to the phase position before switching is required. The change in phase does not have to be determined locally, in particular at the transmitter before transmission and/or at the receiver with respect to the PLL of the receiver, and this change does not have to be corrected in the calculation. The object is achieved by a time synchronisation or a corresponding correction.

### REFERENCE TO RELATED APPLICATIONS

The present application is a National Stage Entry of International Patent Application No. PCT/EP2024/061779 filed on Apr. 29, 2024, which claims priority from International Patent Application No. PCT/EP2023/061372 filed on Apr. 28, 2023.

International Patent Application No. PCT/EP2024/061779 filed on Apr. 29, 2024, also claims priority from European Patent Application No. EP24155873.3 filed on Feb. 5, 2024.

International Patent Application No. PCT/EP2024/061779 filed on Apr. 29, 2024, also claims priority from International Patent Application No. PCT/EP2024/052807 filed on Feb. 5, 2024, which application claims priority from International Patent Application No. PCT/EP2023/061372 filed Apr. 28, 2023.

### BACKGROUND ART

The invention relates to a method for radio-based distance measurement, frequency synchronisation, time synchronisation and in addition to a method for detecting and/or preventing relay attacks.

Methods are known for determining the distance between two objects through the exchange of radio signals between the objects and for carrying out frequency synchronisation or time synchronisation.

Methods are also known in which timers in two objects are synchronised via both wired and wireless links. There is, for example, the NTP protocol. Synchronisation is also possible in the context of a Bluetooth link in which each object has a free-running 28-bit clock with a pulse of 3.2 kHz and where each object determines its offset relative to a central clock and corrects it at regular intervals. Here synchronisation is achieved with an accuracy of approx. 125 ns. An improved time synchronisation is also known from, for example, DE112014004426T5 or “Synchronization in Wireless Sensor Networks Using Bluetooth”, Casas et al., Third International Workshop on Intelligent Solutions in Embedded Systems, 2005., ISBN: 3-902463-03-1. This can be used, for example, to save energy by keeping an object ready to receive only in certain time slots that are known to the other object in order for it to transmit at corresponding times. Synchronisation of the clocks is still possible, at least in the event of relatively strong interference on one side of the radio channel, although the distance measurement becomes impossible or very inaccurate or takes a very long time in the event of such interference. A clear distinction must be made between the accuracy of time synchronisation and synchronisation with a clock pulse of a received signal at the receiver of the signal. In this case no synchronisation of two clocks on two objects takes place; instead the receiving object is set so that it is synchronised with the incoming signal The signal delay is of no significance here, as it does not matter when the signal was sent and/or how long the transmission took.

A method for determining the distance between two objects is also known from WO 2022/096 091 A1 in which the two objects are time-synchronised to 10 ns or better and in which a first and/or second of the two objects transmits signals at several frequencies and the distance between the first and second object is determined, and in which the method includes the decision as to whether/which signals of the first or second object are used, in particular on the basis of at least one estimation or determination of the effects of interference on the reception at each of the two objects. However, coherence information is necessary here.

Furthermore, a method for recognising a relay attack is known from WO 2022/096 514 A1 in which radio signals with different frequencies are transmitted between a first and a second object and phase measurements and delay measurements are carried out on these radio signals and the change in the phase measurements with changes in frequency is compared with the signal delay measurements or their change, and in which a relay attack is assumed if a predetermined deviation or a deviation determined from measurements on the radio signals is exceeded.

Methods are known for distance determination that work with in-line phase return, i.e. that use the measured phase on a received signal and then modify the phase of the response signal transmitted in response to it based on the measured phase by adding the measured phase to a predetermined phase position and transmitting the response signal with the phase position obtained by this addition. A method is known from U.S. Pat. No. 8,446,254 B2, for example, in which the response signal is returned with exactly the phase of the received query signal; this method still has the disadvantage, however, that it lacks time information. This shows a corresponding in-line phase return, in which, for example, the received phase of the query signal is always added to phase zero for the transmission of the response signal. If the predetermined phase here were not zero, but that of a PLL whose phase position relative to the common time is known, this would offer further advantages.

### SUMMARY OF THE INVENTION

The object of the invention is to present a method in which no coherence information is required, in particular neither phase-coherent switching nor switching in such a way that the phase after switching is known relative to the phase position before switching is required, and also the change in phase does not have to be determined locally, in particular at the transmitter before transmission and/or at the receiver with respect to the PLL of the receiver, and this change does not have to be corrected in the calculation.

The object is achieved by a time synchronisation or a corresponding correction.

According to the invention the determination of the distance using radio signals or the detection of relay attacks is based in particular on a distance determination by means of radio signals between two objects, each having a timer, in which the two objects transmit radio signals on several frequencies and the radio signals are received by the respective non-transmitting object of the two objects and the receiving object carries out at least one measurement of the phase and/or at least one measurement of the signal arrival time and/or the signal delay relative to its timer for each frequency and/or radio signal and responds to this signal by transmitting at least one radio signal, in particular on approximately the same or on the same frequency, and in which the respective non-responding object of the two objects receives the at least one radio signal transmitted as a response and carries out at least one measurement of the phase and/or at least one measurement of the signal arrival time and/or signal delay relative to its timer for each frequency and/or radio signal and uses this, and in particular the knowledge of the times of the transmission of characteristics of the signals relative to the timer of the transmitting object and/or based on an in-line phase return, to determine the phase of the radio signal and/or the signal delay relative to its timer, in which, in particular, the received phase is added to the phase otherwise intended for transmission, at least one determination of the phase shift, in particular caused by the transmission, and/or at least one determination of the signal delay per frequency is carried out and, on the basis of the at least one determination, an evaluation is carried out which, in particular, determines the distance between the first and second object and/or determines whether a relay attack is present and/or makes an enable decision,
a determination of a time deviation between the timers of the objects, and in particular also of an at least relative drift of the timers of the objects, is carried out, and the method includes at least for each frequency and/or each signal round trip time period a decision as to whether the measurements on the at least one signal of the first and/or second object are used for the distance calculation and/or the determination, in which the decision is made in particular on the basis of at least one estimation or determination of effects of interference on the reception at both objects, in particular on their ratio and/or difference, in particular on the basis of amplitudes, channel and/or measurement quality indicators, such as, for example, the number and/or frequency of bit errors, signal reception amplitude differences and/or CQI, is carried out, in which for the distance determination and/or calculation, the selected measurements are corrected by the influence of the determined time deviation and the determined drift.

The measurement of the phase shift is to be understood in particular as the phase shift caused by signal propagation of the signal round trip between objects one and two.

The method is advantageously carried out in such a way that, in order to determine the time deviation and/or drift, the relative phase position of two radio signals of different frequencies by means of the PLL of an object is known in each case as a function of the time difference of the generation or transmission of the two signals at one of the objects relative to its timer, in particular by measurement or corresponding generation, and/or the phase position of the PLL of each of the objects at different frequencies is known in each case relative to its timer, in particular by measurement or corresponding generation, with the determination of the time deviation and/or drift between the objects being carried out radio-based by phase measurement(s) on a plurality of the radio signals of different frequencies transmitted between the two objects.

The time deviation and/or drift is advantageously determined by determining the phase shift of the transmission of the forward path signal from the first to the second object and the return path signal from the second to the first object by means of in-line phase return. This enables a particularly simple, reliable and robust implementation.

The in-line phase return is preferably effected by changing the phase position of the return path signal relative to a phase position known to the local timer of the object transmitting the return path signal, in particular the phase position of its PLL, by the negated measured phase of the forward path signal received at the second object.

The negated in-line phase return means that other influences can be largely excluded, especially if this is repeated at different frequencies.

It is therefore preferable to determine time deviation and/or drift based on at least two signal round trips, whereby different frequencies are preferably used for a second/further round trip than for the first/previous round trip. It is therefore preferable to calculate the difference (in particular second degree, i.e. the difference between the differences) of the phase measurements of two round trips.

Multiple forward and return path signals with in particular negated and/or non-negated in-line phase return are therefore advantageously exchanged, in particular at different frequencies. This makes the method not only more accurate, but also more resistant to environmental influences.

The method is preferably performed such that the phase position of a second signal received at the first object is determined at the first object and used together with the phase position of a first signal at the first object relative to the PLL of the first object, in particular the difference between the phase positions, for time synchronisation, in particular the change in the difference between two forward and return path signal pairs exchanged at different frequencies is used as a measure of the relative change in the local timers, in particular as their relative change.

The determination of the time deviation and/or drift, in particular when the distance between the objects is known, is advantageously performed radio-based by means of repeated, in particular of only, unidirectional signal exchange from the first to the second object, in particular at different frequencies, and on the basis of phase measurement(s) on the signal(s) received at the second object, with the phase position of the unidirectional signal of the first object received at the second object being determined in particular at the second object and the phase position of the first signal at the second object relative to the PLL of the second object, in particular the difference from a phase position expected by calculation for identical clocks, is used for time synchronisation.

The method is advantageously performed during and/or with an approximately unchanged radio channel or with an approximately known radio channel, distance and/or approximately known signal path length. This enables particularly accurate results to be achieved.

Particularly preferably, the relative difference of the phase shifts caused by the transmissions between the two unidirectional signals at the first and second frequencies measured on received unidirectional signals at the first and the second frequency, i.e. normalised to the difference between the first and second frequency, is used for time synchronisation, in particular as a measure of the deviation between the local timers, in particular multiplied by the proportionality factor two Pi as the deviation between the local timers.

Advantageously, the determination of the time deviation and/or drift is performed by determining the phase shift of the transmission of the forward path signal from the first to the second object and the return path signal from the second to the first object by means of in-line phase return, in which in particular the in-line phase return is achieved by changing the phase position of the return path signal relative to a phase position known relative to the local timer of the second object, in particular the phase position of its PLL, by the negated measured phase of the forward path signal received at the second object at the second object.

The negated in-line phase return is preferably achieved in particular by changing the phase position of the return path signal relative to a phase position known to the local timer of the object transmitting the return path signal, in particular the phase position of its PLL, by the negated measured phase of the forward path signal received at the object transmitting the return path signal.

For particularly robust and/or precise implementation, multiple forward and return path signals are preferably exchanged with in-line phase return.

The method is advantageously performed in such a way that the phase position of the second signal received at the first object is determined at the first object and is used together with the phase position of the first signal at the first object relative to the PLL of the first object, in particular the difference between the phase positions, for determining the time deviation and/or drift, in particular the change in the difference between two forward and return path signal pairs exchanged at different times and in particular with, at least approximately, identical frequencies, is used as a measure of the frequency deviation.

The relative difference in the phase shifts caused by the transmissions between the two unidirectional signals at the first and second times, measured at two different times on received unidirectional signals, i.e. first and second time, normalised to the difference between the first and second times, is preferably used as a measure of the deviation of the PLLs of the two objects, in particular as the deviation of the local PLLs of the objects

Advantageously, the phase position of the unidirectional signal of the first object received at the second object is determined at the second object and the phase position of the first signal at the second object relative to the PLL of the second object, in particular the difference to a phase position expected by calculation at the same frequencies of the PLLs of the two objects, is used for time synchronisation.

Depending on the configuration, the distance can preferably be determined by a phase-based distance measurement and/or a delay-based distance measurement.

Advantageously, if a relay attack is suspected and/or as an enable decision an access or enable is denied, a requested activity or action is not performed and/or an alarm or blocking is performed, and/or if a relay attack is not suspected and/or as an enable decision the access or enable is granted and/or the requested activity or action is performed and/or the alarm or blocking is not performed.

In order to detect a relay attack, radio signals, in particular with different frequencies (f1, f2, f3), are preferably transmitted between the first and second object (01, 02) and phase measurements are carried out on a first subset of the radio signals, in particular signals with different frequencies, with different frequencies and these are compared with a reference, whereby a relay attack is assumed if a predetermined deviation or a deviation determined from measurements on the radio signals is exceeded, an access or enable is denied, a requested activity or action is not carried out and/or an alarm or block is carried out and/or if the deviation falls below the predetermined deviation or deviation determined from measurements, in particular signal propagation measurements, the absence of a relay attack is assumed, an access or enable is granted and/or the requested activity or action is carried out and/or the alarm or block is not carried out, in which a signal delay measurement is carried out on a second subset of the radio signals, in particular signals with different frequencies, which is in particular at least partially identical to the first subset, a signal delay measurement is each carried out on each of the signals, a measurement series based on the phase measurements and/or a reference measurement series based on the signal delay measurements, in each case, in particular as a function of the frequency of the frequencies of the radio signals used for the measurement, the measurement series and/or signal delay measurement series advantageously being either a, in particular strictly, monotonically increasing or, in particular strictly, monotonically decreasing sequence of frequencies, monotonically decreasing sequence of frequencies and in which a filtered and/or smoothed measurement series is advantageously determined based on this measurement series and/or a filtered and/or smoothed reference measurement series is advantageously determined based on the reference measurement series and that the filtered and/or smoothed measurement series, in particular its change over the frequency, is/are compared with the at least one signal delay measurement and/or the reference measurement series as a reference and/or in which the measurement series or its change is compared with the filtered and/or averaged reference measurement series and/or in which the measurement series is compared with the reference measurement series, in particular its change.

Subsets have in particular at least partially similar frequencies, for example identical and/or neighbouring frequencies in the radio protocol used. In particular, one frequency is similar to another frequency if the frequency difference at frequencies above 1 GHz is at most 5 MHz, in particular at most 3 MHz. One, in particular the smaller, of the first and second subsets, in particular at least 50%, in particular at least 90%, preferably 100%, of the frequencies of the radio signals contained in one subset are similar and/or identical to those contained in the other of the first and second subsets, whereby in particular each frequency of the other is only ever considered to be similar for a maximum of one frequency of the one, in particular if for frequencies of the one it is determined that similar or identical frequencies are present in the other.

With particular advantage, the method is performed in such a way that for each measurement of one of the first or second subsets, there is a measurement which is similar or identical in terms of frequency, in particular a similar measurement (in particular no more than 5 MHz deviation) with a higher frequency and a similar measurement with a lower frequency, in the other of the subsets, that has been carried out in a close tem-poral relationship and/or with an essentially unchanged radio channel. An essentially unchanged radio channel can be ensured in particular by a close temporal relationship, whereby this depends on the movement of the objects and the changes in the real envi-ronment and the changes in radio interference, in particular in relation to the wavelength. The effects should result in a phase change of less than 90° between the measurement times. A sufficiently close temporal relationship can generally be assumed if the time interval is less than 10 ms, especially for frequencies in the GHz range. At 2.4 GHz, for example, the wavelength is approx. 12 cm, with a maximum assumed movement speed of 4 m/s (brisk jogging)=3 cm per 7.5 ms, the time interval could be chosen as less than 7.5 ms.

In the event of a change in a series of measurements over the frequency, its change over a frequency range or in relation to the frequency must be considered in particular, for example the gradient in a representation in relation to the frequency.

The comparison does not have to be made after conversion into distances; the deviation can also be predetermined in other units that allow a comparison.

Conversion is possible in particular by means of the correlation

Phase_shift=2 Pi*(distance)*frequency/c, whereby consideration must be given to the fact that above a given distance, a certain ambiguity has to be taken into account and c=the speed of light

$$RTT = 2 * distance / c$$

and consequently, neglecting the ambiguity:

$$Phase\_shift = Pi * ( RTT * c ) * Frequency / c$$

$$and / or$$

$$dPhase\_shift ( f 1 , f 2 ) = Pi * ( RTT * c ) * dFrequency ( f 1 , f 2 ) / c$$

and hence (again considering the ambiguity)

$$dPhase\_shift {( f 1 , f 2 )}_{RT} / dFrequency ( f 1 , f 2 ) = Pi * RTT$$

Whereby consideration must be given to the fact that ambiguity arises at distances greater than c/dFrequency. In most applications, however, the frequency spacing can be selected such that no ambiguities arise, at least for distances of less than 150 me-tres. In particular, the possible distance and/or frequency difference dFrequency is/are selected such that no ambiguity arises or such that ambiguity can be neglected. In particular the distance is less than the speed of light divided by the frequency difference of the measurement of the phase shift, in particular at least half less, in particular less than 300 metres, in particular less than 150 metres.

The phase shift (f1, f2)_{RT} here is a phase shift between the transmissions at the frequencies f1 and f2 from one object to the other and back caused by the distance. It can be approximately equated to twice the phase shift that occurs during transmission from one object to the other due to the distance. Furthermore, dPhase_shift (f1,f2) is the possibly corrected distance-related phase shift difference of the radio signals received at frequency f1 and frequency f2, dFrequency is their difference and c is the speed of light. RTT is the signal round trip time from one object to the other and back. Instead of ac-cepting the ambiguity problem, the ambiguity can also be resolved by other methods and formulated by adding the determined correction term to resolve the ambiguity.

Conversions are also conceivable, for example, to a free or dimensionless quantity and/or by means of transformation, for example FFT. If a parameter with a new dimen-sion is calculated for comparison using FFT, the larger subset is preferably reduced so that it has the same or a similar size, in particular one that differs by a maximum of 10%, to that of the smaller subset, in particular by reducing it so that at least 90% of, in particular each, frequency of the measurements of the smaller subset is as similar as possible, whereby in particular only 1:1 assignments are made.

In order to accelerate the determination of the distance and/or to increase the accuracy of the determination of the distance between two objects and/or in the event of interfer-ence in the reception of one of the two objects, it is desirable to carry out the distance determination while largely dispensing with the radio signals of one transmission direc-tion. The object of the present invention to accelerate the determination of the distance, to enable it to be determined with greater accuracy and/or to enable or improve it even in the event of interference on one side of the radio link.

The inventor was surprised to discover that it is possible to dispense with one transmission direction between time and/or clock-synchronised objects. This allows faster measurement, as the switching times of the transceivers can also be largely dispensed with and enables the distance to be determined even if there is heavy interference on one side of the radio channel.

In particular, the distance between the first and second object is determined, with the two objects being time and/or clock synchronised to 10 ns or better, in particular in the range between 10 ns and 100 ps, and with a first and/or second of the two objects transmitting signals on several frequencies and the second and/or first of the two objects receiving these signals and determining the distance between the first and second object from this and from the knowledge of the times of the transmission of characteris-tics of the signals, in particular at least one characteristic per frequency and/or per signal. It is possible here that only the first object transmits and the second object receives the signals from the first object, or that the second object transmits and the first object receives the signals from the second object. It is also possible to combine the two, in particular one after the other or alternately.

Characteristics of the signal include, in particular, changes in the signal, such as changes in amplitude, polarisation, the radiating antenna (change between antennas), frequency and/or phase. However, aggregated groups of characteristics can also be used, which increase the robustness of the method in some situations. For example, modulated packets or sync words can be used as groups of characteristics.

In a possible preferred embodiment, in particular for determining the distance, only the signals transmitted by the first object or, in particular exclusively or, the signals transmitted by the second object are used. In a particular embodiment, this decision can also be taken individually for each frequency or for frequency groups, frequency ranges or frequency sub-bands. Particularly in the case of good transmission ratios on both sides or similar transmission ratios on both sides, signals from both objects can also be used for certain frequencies, frequency groups, frequency ranges or frequency sub-bands or for all frequencies.

In a further preferred embodiment, a decision is made as to which of the signals of the first or second object are to be used, in particular to determine the distance. In a particular embodiment, this decision can also be taken individually for each frequency or for frequency groups, frequency ranges or frequency sub-bands. Particularly in the case of good transmission ratios on both sides or similar transmission ratios on both sides, signals from both objects can also be used for certain frequencies, frequency groups, frequency ranges or frequency sub-bands or for all frequencies.

Embodiments are possible here in which only the first object transmits, in which only the second object transmits as well as embodiments in which both objects transmit, but in which only part of the signals, namely those transmitted by the first object or, in particular exclusively or, those transmitted by the second object, are used to determine the distance. This does not apply to signals for time or clock synchronisation that can be used by both objects irrespective of the decision.

The decision as to whether the signals of the first or, in particular, second object are used and/or which of the signals of the first or second object are used can be taken b-fore or after transmission of the signals or after transmission of part of the signals.

If the speed is to be increased, it is preferable to take the decision as early as possible and to minimise the transmission of unused signals, in particular not to transmit them after the decision has been taken. If the method is to be designed to be as interference-free as possible, the decision is only taken after the signals of the first and second objects have been transmitted. Transmitted and received signals can be used as the basis for the decision. Other data or measurements can also be used as an alternative or in addition here, such as noise or signals not related to the method at the receiver. Knowledge of the general interference level at the locations of the two partners can also be used for the decision.

In particular, the first or, in particular exclusively or, of the second object whose recep-tion had, has or is likely to have less interference at the other of the two objects is selected for determining the distance. In a particular embodiment, this decision can also be taken individually for each frequency or for frequency groups, frequency ranges or frequency sub-bands. Particularly in the case of good transmission ratios on both sides or similar transmission ratios on both sides, signals from both objects can also be used for certain frequencies, frequency groups, frequency ranges or frequency sub-bands or for all frequencies.

In particular, the signals of the first or, in particular exclusively or, of the second object whose reception had, has or is likely to have less interference at the other of the two objects is selected for determining the distance. In a particular embodiment, this decision can also be taken individually for each frequency or for frequency groups, frequency ranges or frequency sub-bands. Particularly in the case of good transmission ratios on both sides or similar transmission ratios on both sides, signals from both objects can also be used for certain frequencies, frequency groups, frequency ranges or frequency sub-bands or for all frequencies.

The decision is taken in particular in such a way that the signals, in particular of a frequency, a frequency group or frequency range or a frequency sub-band of the first or, in particular exclusively or, of the second object, whose reception at the other of the two objects had, has or is likely to have more interference than the signals, in particular of the frequency, the frequency group or frequency range or the frequency sub-band, of the other of the two objects, are not selected and/or are not used for the determination. The decision is taken in particular in such a way that the signals, in particular of a frequency, a frequency group or frequency range or a frequency sub-band of the first or, in particular exclusively or, of the second object, whose reception at the other of the two objects had, has or is likely to have less interference than the signals, in particular of the frequency, the frequency group or frequency range or the frequency sub-band, of the other of the two objects, are selected and/or are used for the determination.

In the event of equally strong interference to the reception of the signals of the first object and the second object, in particular a frequency, a frequency group or frequency range or a frequency sub-band, both, one or neither of the signals can be used. The decision is preferably taken on the basis of the strength of the interference, in particular with respect to other frequencies, frequency groups or frequency ranges or frequency sub-bands in which the first and/or second signals were or are transmitted. In a particularly simple embodiment, the signals of the first exclusive object or the signals of the second object or none of the signals are selected and/or used in this case.

The interference can be assessed, for example, using the signal-to-noise ratio, the car-rier-to-noise ratio, the bit error frequency or probability, the symbol error frequency or probability or other measured variables or methods for assessing the signal quality or quality of the transmission channel, as is also known, for example, from EP 0 664 625 A2.

The signals are in particular radio signals.

It was also surprisingly discovered that the distances obtained from the one-sided distance measurement described here or the distance measurement according to the in-vention when using commercially available transceivers such as the somewhat older cc2500 or the current cc26xx from Texas Instruments or the Kw35/36/37/38 from NXP or the DA1469x from Dialog are dependent on the frequency used to determine the distance. Inaccuracies in the transceivers also appear to lead to calculated distances b-low the actual distance, but only at frequencies whose transmission channel is heavily attenuated, so that these can be easily eliminated in the calculation.

Thus, when determining the distance, it is advantageous to partially not use signal com-ponents of the object whose signals are used to determine the distance, namely not to use such components that are above an upper power limit and/or not to use such com-ponents that are below a lower power limit. These limits can be predetermined or determined from the received signals and in particular lie above or below the average received power and in particular lie at least 20% above the average received power (upper power limit) and/or at least 20% below the average received power (lower power limit).

Signal components at frequencies with less than 40% or at least signals with less than 20%, in particular less than 40%, of the average energy of the signals and/or signals with more than 140%, in particular more than 120%, of the average energy are preferably not taken into consideration.

The lower power limit lies advantageously in the range of 5% to 50% of the average power of the received signals and/or the upper power limit lies advantageously in the range of 120% to 200% of the average power of the received signals.

In another embodiment, the x % of the signals with the smallest received amplitude are identified from the signals selected, in particular in the decision, and not used and/or the y % of the signals with the largest received amplitude are identified and not used. It has proved to be particularly advantageous if the sum of x and y does not fall below 10 and/or does not exceed 75 and/or x is in the range from 10 to 75 and/or y is in the range from 20 to 50. With these values, a high level of accuracy and reliable distance determination can be achieved in most situations.

Advantageously, the second or, in particular exclusive or, first object does not transmit any signals to determine the distance and/or the second or the first object, in particular exclusive or, only sends signals for time and/or clock synchronisation. This allows en-ergy and process time to be saved.

The first and/or second or each of the two objects preferably transmits the signals at a plurality of frequencies one after the other and/or consecutively, in particular immedi-ately after each other. In particular, when the first and second objects transmit, all the signals of the first or second object are transmitted first and then those of the other object. This makes it possible, among other things, to reduce the effects of changes in the environment or distance and of movements of one or both objects.

The advantage is that the bandwidth of the signals never exceeds 50 MHZ, in particular 25 MHz. This allows energy to be saved, interference with other processes to be avoided and simple parts to be used compared with broadband methods.

At least one time and/or clock synchronisation and/or correction is preferably performed between the two objects before, after and/or during the execution of the method. This increases the accuracy of the method. A drift of the clock of the first and/or second object or a difference in the drift of the clocks of the first and second objects is also preferably determined and taken into consideration when determining the distance. This in-creases the accuracy of the method.

The method is advantageously performed such that the frequency spacing between two successive frequencies of the plurality of frequencies is at least 0.1 MHz and/or at most 10 MHz and/or the plurality of frequencies represent at least five frequencies and/or at most 200 frequencies and/or in which the plurality of frequencies span a frequency band of at least two MHz and/or at most 100 MHz. This allows a balance to be achieved between bandwidth requirements that make demands on available frequencies and hard-ware, and accuracy.

The method is preferably performed such that the accuracy of the distance determination is in the range of 0.3 m to 3 m, in particular at least for distances in the range of 0 to 50 m. The advantages of the invention are particularly evident in these ranges.

Advantageously, the distance determination is based on determining the signal delay from the first to the second or from the second to the first object and/or on determining the phase shift of the signals from the first to the second or from the second to the first object

The component of the shortest signal path (the shortest distance recognisable in the signal) in the received signal can also be identified using FFT and/or high-resolution methods such as MUSIC or CAPON. For this, the signal components of the shortest path between the two objects (in particular the transmitter and receiver) are isolated using FFT and/or high-resolution methods and only these are used for the further application, in particular the phase measurement.

For each signal received at the second and/or first object, a value proportional to its am-plitude and a phase value is advantageously determined and, in particular, a complex number is determined from this that is used to determine the distance between the first and second objects. The phase value is determined in particular by calculating a change in phase shift normalised to a frequency spacing with respect to a plurality of pairs of signals with neighbouring frequencies, i.e. approximately calculating the derivative of the phase shift at the frequency or one of the frequencies of the pair and the values collected in this way are used to determine the phase and/or the argument of the complex number at the respective frequency (the value proportional to the amplitude), in particular by approximate integration over the frequency. It is not necessary to start the integration at f=0 Hz; an offset common to all phases and/or complex numbers can and is preferably used, in particular the lowest frequency of the, in particular selected, signals. In particular, the phase value and/or the argument of the complex numbers is determined from the signal delay or signal round trip time.

In particular, the normalised phase shift change (dPhase_shift (f1,f2)) is obtained using the formula:

$$dPhase\_shift ( f 1 , f 2 ) = a * RTT ( f 3 ) * dFrequency ( f 1 , f 2 )$$

where dFrequency(f1,f2) is the difference between the frequencies f1 and f2, RTT (f3) is twice the signal delay or signal round trip time between the first and second object at one or more frequencies f3, similar to f1 and/or f2 and/or vice versa, and where a is a constant, in particular equal to 2*Pi.

The complex value Z for a frequency is then calculated in particular using:

$$Amount ( Z ( f ) ) = ( b * Amplitude ( f ) + offset )$$

$$Argument ( Z ) ( f ) ) = Sum ( dPhase\_shift ( f 1 , f 2 ) * dFrequency ( f 1 , f 2 ) ) for f 1 from f 0 bis f$$

The phase shift changes are therefore totalled with the frequency distances from the lowest frequency to the frequency in question for which the complex number is to be determined.

Here, b and offset are constants and b is in particular 1 and offset is in particular 0. Amplitude (f) is the received amplitude measured at frequency f or an average of a plurality of amplitudes measured at frequency f and/or at frequencies similar to f.

The phase shift here is a phase shift during the transmission at the frequency from one object to the other and back caused by the distance. It can be approximately equated to twice the phase shift that occurs during the transmission at the frequency from one object to the other due to the distance.

In particular, a matrix, in particular an autocorrelation matrix, is formed from a plurality of the complex numbers and the distance is determined using these known methods, for example MUSIC, CAPON, comparison with, distance calculation to and/or projection onto emission and/or reception characteristics. The distance is advantageously calculated by means of eigenvalue or eigenvector determination of the at least one matrix and/or Fourier transformation of the complex values.

Such methods are particularly advantageous for multipath signal propagation in order to achieve a reliable determination.

Regardless of the use of complex numbers, autocorrelation matrices, etc., however, it is advantageous to work with differences in phase shifts between measurements with different frequencies for the distance determination, as this allows other influences to be avoided. For example, using

$$dPhase\_shift = 2 Pi * ( 2 * distance ) * dFrequency / c$$

it is possible to easily determine the distance between the objects using the difference in the phase shifts for two signal round trips between the two objects, once at a first and once at a second frequency, with the frequency spacing dF. The same equation can also be used for unidirectional signal exchange or when using signals only via the forward or return path between the first and the second object:

$$dPhase\_shift ( from the first to the second object ) = 2 Pi * ( distance ) * dFrequency / c$$

$$or$$

$$dPhase\_shift ( from the second to the first object ) = 2 Pi * ( distance ) * dFrequency / c$$

It is advantageous to determine an average value from a plurality of distance measurements and/or to average the measurements to determine a distance value.

If localisation is desired, it is advantageous to perform the inventive method between a plurality of pairs of objects, in particular with one object of each pair being an object that belongs to all pairs, and with the determined distances of the pairs being used to per-form a mapping and/or position determination for at least one of the objects. In particular, it is advantageous to perform these pairs of measurements simultaneously.

The object is also achieved by one or two objects or systems, each equipped with transmitting and receiving means and a control system, configured to perform the inventive method.

Advantageously, the objects are parts of a data transmission system, in particular of a Bluetooth, WiFi or mobile radio data transmission system. The signals are preferably signals of the data transmission system, in particular of a data transmission standard, for example mobile radio standard, WiFi or Bluetooth, that are used for data transmission in accordance with the data transmission standard.

The signals are advantageously transmitted via a plurality of antenna paths, in particular at least three, in particular transmitted with a plurality of antennas, in particular one after the other, at the transmitting object and/or received with a plurality of antennas at the receiving object.

The calculation is carried out, for example as follows: When averaging the measured distances, the measurements of the received signals with less than, for example, 40% of the average energy of the received signals are ignored. This therefore excludes measurements on frequencies with a strongly attenuated transmission channel.

The exact time difference and time drift between the two objects are also determined, and the reception times of characteristics of the signals whose transmission times are known are measured on n >1 frequencies.

The results can be used to determine the distance in various ways, for example:

### Calculation 1

The sum (RTTASUM) of each of the signal delays before summation is multiplied by the respective amplitude, and the sum (ASUM) of all amplitudes is calculated. The division RTTASUM/ASUM then provides a useful estimate of the signal delay from which a distance can be easily determined.

### Calculation 2

All measurements with a received amplitude of less than 40% of the average received amplitude are discarded. Of the remaining signal delays, the 20% shortest signal delays and the 50% longest delays are discarded.

The remaining 30% of the signal delays are averaged. A distance can then be determined directly from this,

### Calculation 3

All signal delays or signal round trip times (RTT) are each converted into a phase shift difference or phase shift derivative:

$$dPhase\_shift = 2 Pi * ( 2 * distance ) * dFrequency / c$$

$$RTT = 2 * distance / c$$

$$dPhase\_shift = 2 Pi * ( RTT * c ) * dFrequency / c$$

Here, dPhase_shift is a distance-related phase difference between two frequencies that have the distance dFrequency or also a difference between two distance-related phase shifts between transmissions at two frequencies that have the distance dFrequency. c is the speed of light.

The calculated phase shift changes are then added: sumPh (Fn)=sum dPhase_shift (F0 . . . . Fn)

F0 to Fn are the plurality of frequencies.

These cumulated dPhase_shifts, each as an argument of a complex number with the corresponding amplitudes determined at reception or with proportional values as the magnitude of the complex numbers, can then be entered as complex values in a Fourier transformation, or they can be used to estimate a spectrum in matrices using super resolution methods (e.g. MUSIC or CAPON). The spectrum is then the spectrum of paths of different widths that the signal covers before it arrives superimposed at the receiving antenna. Here it is particularly advantageous to use a plurality of antenna paths during transmission and to include these in the analysis.

For time synchronisation and/or determination of a deviation between timers, but alter-natively or additionally also for frequency synchronisation and/or determination of a frequency deviation of local PLLs of the objects, this method—but also alone as a sepa-rate invention between two objects (e.g. first and second anchor)—in particular with a known phase relationship of the transmitted signals and/or PLLs, in particular relative to the respective local timer of the respective transmitting object of the two objects, preferably also using an in-line phase return, whereby the addition known for determining the distance is replaced by a subtraction (negated in-line phase return). This enables a particularly fast synchronisation and/or determination, in particular if the distance and/or the radio signal path length(s) between the two objects is known and/or constant, but also without knowledge of the distance when repeated with different frequencies.

For this, a radio signal in particular with a first frequency is transmitted from the first object to the second object and the second object responds by transmitting a second radio signal, in particular also with approximately the first frequency, to the first object. This signal round trip is preferably repeated, but at a second frequency different from the first frequency. The repetition is performed in particular several times, in particular at a plurality of frequencies, such that the frequency spacing between two successive frequencies with respect to the frequency and/or the time sequence of the plurality of frequencies is at least 0.1 MHz and/or at most 10 MHz and/or the plurality of frequencies represent at least five frequencies and/or at most 200 frequencies and/or in which the plurality of frequencies span a frequency band of at least two MHz and/or at most 100 MHz.

The transmitted and received radio signal is preferably broken down into signal path components and one or more signal path components are always considered separately for the following determinations, in particular one or more components whose radio signal path length is known. Alternatively or additionally, known methods can be used to try to reduce multi-pathing, for example by selecting suitable frequencies.

If, for example, the phase positions relative to the local timers of the two objects are known, i.e. the phase position of the PLL or the transmitted signals of the first object to the timer on the first object and the phase position of the PLL or the transmitted signals of the second object to the timer on the second object are known, the two timers can be synchronised quickly and easily using (negated) in-line phase return. This can also be used to determine the frequency deviation between the PLLs of the two objects.

The frequency deviation between the PLLs of the two objects (CFO crystal frequency offset) that can be used directly for frequency synchronisation can, for example, be determined using the following equation:

$$CFO = 1 / 2 * ddPhase ( t 2 , t 1 ) / ( 2 * Pi ) / ( t 2 - t 1 ) ,$$

where ddPhase (t2,t1) is the measured change between the phase shifts of two response signals of the second object (second-degree difference), with the second object having transmitted these two response signals to the signals transmitted at the first object at time t1 and at time t2 of the timer at the first object (one to the signal transmitted at time t1 and one to the signal transmitted at time t2) and these two response signals have been received at the first object, and with the second object, when transmitting the response signals, having already subtracted the phase of the signals transmitted at times t1 and t2, respectively, from the phase position known relative to the timer of the second object (negated in-line phase return). In each case, the phase shift is the phase shift caused by the radio channel and/or the transmission of the signals (in the case of a round trip (one signal each from the first object to the second and from the second to the first) with negated in-line phase return). The change in the phase shift is then to be understood in particular as the change in the phase shift from the first (starting at t1) to the second (starting at t2) round trip with negated in-line phase return, i.e. the second-degree difference.

The signals of a round trip advantageously have similar, in particular approximately identical or identical frequencies. Approximately identical frequencies are in particular frequencies that are considered identical due to the existing synchronisation, their deviation is not greater than the current CFO and/or their difference is not more than 100 MHz.

A larger time interval between the round trips and/or t1 and t2 results in greater accuracy and is therefore to be preferred. Attention must be paid here to the uniqueness of (2*Pi)/2. Depending on how precisely the CFO was already known before the measurement, the time interval between the round trips can be optimised so that it is chosen to be large, but the uniqueness is reliably maintained. In practice, in particular with an existing CFO of 100 Hz or better (lower), time intervals between t1 and t2 or the round trips in the range of 0.3 to 50 ms have proven successful, whereby further measurements with increasing time intervals are preferably carried out subsequently, in which accuracies achieved on the basis of the previous measurement(s) are taken into account in each case in order to set the time intervals as large as possible while still maintaining the uniqueness.

The frequencies of the signals transmitted at time t1 and at time t2 of the timer on the first object are preferably selected to be identical and the frequencies of the response signals of the second object to the signals transmitted at time t1 and to the signal transmitted at time t2 of the timer on the first object are also selected to be identical, in particular also approximately identical to the frequencies of the signals transmitted at time t1 and at time t2 of the timer on the first object. This means, in particular, that they were synchronised to the extent possible with the available information and means.

If the time synchronisation is accurate enough and the distance and/or signal path length is known, the method can also be carried out unidirectionally and even with just one signal on one frequency. If a signal with a frequency and known phase position is transmitted at the first object at a known time, the expected phase position at the second object can be calculated. If the real phase position is measured, the CFO can be calculated from this. However, all errors relative to the signal path length, time synchronisation and phase measurement then have a direct influence on the determination of the CFO. This is therefore used in particular only in addition to an inventive time synchronisation.

The method is preferably repeated at several different frequencies (e.g. fa and fb) at different times (e.g. ta for the start of the implementation at fa and tb for the start of the implementation at the frequency fb; t1 is then in particular equal to ta in each case). The frequencies are preferably not linearly spaced relative to the time of execution (e.g. ta and tb) or have only a low linear dependence, in particular of less than 10%. The linear dependence is low in particular if the two-dimensional vectors, each consisting of frequency and transmission time, have a linear component of less than 10% relative to one another. This is the case, for example, in pairs of two such vectors if the projection of the one onto the other has a length of less than 10% of the length of the one.

Thus, in particular with fb-fa=Kab*(tb-ta) for different pairs fa and fb, Kab is not the same for all pairs, in particular it is different for all pairs. In another preferred but technically more sophisticated embodiment, the method is carried out at several frequencies simultaneously.

The time difference (dT) that can then be used directly for synchronisation can be determined, for example, using the following formula:

$$d T = 1 / 2 * ddPhase ( f 2 , f 1 ) / ( 2 * Pi ) / ( f 2 - f 1 ) ,$$

where ddPhase (second-degree difference) is the measured change between the phase shifts of two response signals of the second object with the second object having transmitted these two response signals to the signals transmitted at the first object with the frequency f1 and frequency f2 (first signal at f1, second signal at f2) and these two response signals (one to the signal at f1 with also approximately frequency f1 and one to the signal at f2 with also approximately frequency f2) have been received at the first object and, with the second object, when transmitting the response signals, having in each case already subtracted the phase previously received there of the signals transmitted by the first object from the phase position known per se relative to the timer of the second object (negated in-line phase return), i.e. in particular has in each case rotated the transmitted phase of the response signals by the negative received phase of the respective previously received signal. One response signal is the response signal that is sent to the signal sent at frequency f1 and one response signal is the response signal that is sent to the signal sent at frequency f2.

The measurement of the round trip of the first signal at f1 and the corresponding response signal and the measurement of the round trip of the second signal at f2 and the corresponding response signal is advantageously carried out with a time interval in which the channel has not changed significantly, in particular at the same time. A CFO also leads to deviations if the measurements are not performed at the same time. Although the deviation can be mathematically calculated if the CFO is approximately known, it is advantageous to avoid it or keep it small. In practice, a maximum time interval of 100 ms has proved to be appropriate.

Signals for determining the frequency deviation and/or frequency synchronisation are advantageously also used to determine the time difference and/or time synchronisation, or vice versa. In particular, frequency hopping is used for this, especially with non-equidistant frequency intervals and/or frequency intervals that are small or non-linear compared to the transmission time. In particular, this is therefore a method for determining the frequency deviation and/or frequency synchronisation on the one hand, and for determining the time difference and/or time synchronisation on the other.

The methods are preferably repeated individually or together for several different frequency pairs (e.g. several pairs fa and fb) at identical or different times (e.g. ta1 for the start of the execution at fa1 and fb1 and ta2 for the start of the execution at the frequencies fa2 and fb2). The frequencies and/or frequency differences preferably exhibit little or no linear dependence with respect to the time of execution.

It is therefore so that, in particular with (fb1−fa1)/(fb2−fa2)=K12*(ta1−ta2) for different pairs of pairs fan/fbn and fam/fbm, Knm is not the same for all pairs, and in particular is different for all pairs of pairs.

In another preferred but technically more sophisticated embodiment, the method is carried out for several pairs of frequency pairs simultaneously.

The radio signal exchange between the anchors/objects for time synchronisation takes place in a preferred embodiment, in which fast switching between the transmission frequencies is possible, in particular in relation to the time for switching the transmit ampli-fier on and off, so that first one object (e.g. first anchor) transmits, in particular one after the other, on different frequencies and then another object (e.g. second anchor) transmits, in particular one after the other, on different frequencies. This allows the time required to be reduced.

The radio signal exchange between the objects for time synchronisation takes place in another preferred embodiment, in which there is a slow switchover between the transmission frequencies, particularly in relation to the time for switching the transmitter am-plifier on and off, so that the objects only transmit one signal at a time on one frequency, i.e. they always alternate. This allows the time required to be reduced.

In a further preferred embodiment in which the, in particular ongoing, time synchronisation of the objects/anchors, in particular after an initial (possibly also arbitrary) time synchronisation, is carried out at and/or during an approximately constant radio channel (reference channel) (e.g. if the average distance of the transmitted energy of the radio channel changes by less than 1 m, in particular by less than 10 cm, during and/or during the time synchronisation and/or the time synchronisation is carried out in such a way that this condition is met) between the anchors can be carried out radio-based, this is preferably carried out in such a way that the time synchronisation, in particular continu-ous time synchronisation, is carried out between two anchors, in particular repeated several times and/or continuously, by means of unidirectional signal exchange on several frequencies and on the basis of phase measurements on the exchanged unidirectional signals.

This can be obtained, for example, from the following equation:

Let dPh (F2,F1) be the relative change (i.e. normalised to the difference between the frequencies F1 and F2) in the phase shift (second-degree difference in the phase shift) between the two unidirectional signals at F1 and F2 (caused by the transmission channel) measured on received unidirectional signals at frequencies F1 and F2, for example from the first to the second anchor, let ddPh ((F2,F1), t2, t1) be the relative phase shift difference, i.e. the phase shift measured at time t2 corrected for the effect of the transmission channel, i.e.

$$ddPh ( ( F 2 , F 1 ) , t 2 , t 1 ) = dPh ( F 2 , F 1 ) ( t 2 ) - dPh ( F 2 , F 1 ) ( t 1 )$$

with dPh (F2,F1) (t2) as dPh (F2,F1) of a signal transmitted or received at time t1 and dPh (F2,F1) (t1) as dPh (F2,F1) of a signal transmitted or received at time t2,
then ddPh ( ) is proportional to the shift dT of the time base between the objects/anchors between the times t1 and t2.

The time shift dT can therefore be calculated as:

$$dT = ddPh ( ( F 2 , F 1 ) , t 2 , t 1 ) / ( 2 * pi ) / ( F 2 - F 1 )$$

The change in the measured phases, in particular phase shifts, in particular at a plurality of frequencies, is therefore preferably considered with the “reference measurement” with known time synchronisation (t1). Measurement at different frequencies, the distance between which is preferably chosen to be large, in particular in the range of 50-500 MHZ, enables a particularly error-tolerant determination to be achieved, which in particular places less demand on the CFO and the previously existing coarse time synchronisation and yet avoids the ambiguity problem quite reliably, because a measurement is only carried out virtually, so to speak, at the difference frequency. For example, if the measurement is carried out in the 2.4 GHz band with the frequencies 2400 and 2480 MHz, the difference is only 80 MHz. In this case, 12 ns corresponds to a 360° phase rotation, so that with an accuracy of the phase measurement in the range of +/−3 to 6°, quite good time synchronisation can be achieved, and this with only low requirements in terms of avoiding ambiguity problems with regard to the phase position.

The rate of change of the time synchronisation from time t1 to time t2 is then:

$$ddT = dPh at time 2 - dPh at time 1 = ddPh ( ( F 2 , F 1 ) , t 2 , t 1 ) / ( t2 - t 1 ) .$$

ddPh ((F2,F1),t2, t1) can also be replaced by an averaging of several ddPh ((Fn,Fm),t2, t1) with a plurality of frequency pairs Fn, Fm. This can increase the accuracy.

ddPh is therefore the change in the phase shift measured at the second object (in each case previously adjusted for the phase shift caused by the transmission channel) between signals received at the second object transmitted at the first object at times t1 and t2.

If the measuring arrangement is sufficiently accurate, in particular if the signal path length is known with sufficient accuracy, the CFO is sufficiently small and the phase measurement is sufficiently accurate, the time deviation can also be determined simply using a unidirectional signal. If a signal with known phase position is transmitted from the first object at one frequency and its phase position is determined at the second object, this can be compared with the expected phase position and dT can be determined directly from the deviation. However, particularly at high frequencies, this requires a high level of accuracy in order to avoid ambiguity.

The accuracy can be considered to be sufficiently high if the ambiguity of the phase measurement can be reliably avoided. This can be determined mathematically from the frequency used.

In general, the frequencies used in this text are preferably above 2 GHz. This enables a high level of accuracy to be achieved and allows existing transmitters, such as Bluetooth, WiFi and/or mobile communications, e.g. LTE, to be used.

The objects, or at least some of the objects, advantageously form an anchor network. The anchor network, whose anchors are time-synchronised with one another and whose distances, in particular at least relative positions, are determined/known, makes it easy to create an infrastructure for localising objects.

The distance between the anchors/objects and/or their relative position is advantageously determined using radio-based distance measurements between pairs of anchors/objects. This means that other measurement methods, such as manual or light-based methods, can be completely dispensed with. This reduces the amount of equip-ment required. It also makes it possible to quickly and easily set up, for example, ad hoc anchor networks. This can be helpful in emergency situations, for example, to track down a radio node such as a mobile phone. For example, a group of people who are each carrying a radio node, for example in the form of a mobile phone, can set up an anchor network using the radio nodes of the remaining people if one of the people is lost or buried and the radio node of the lost or buried person can be quickly located. For this purpose and in general, the radio nodes can, for example, determine their relative position using GPS and/or radio-based distance measurement. After an initial determination, the position of some or all anchors can also be adjusted in order to improve the determination in a further implementation of the method. This allows precise localisation to be achieved very quickly and reliably. For this, the position of the anchors is changed, in particular iteratively, so that they are arranged, in particular uniformly, around the radio node to be located. To do this, some or all of the anchors can move t-wards the approximate position between measurements, in particular from different sides, while maintaining a minimum distance, in particular a predetermined distance, between the anchors, e.g. 2 metres.

It is preferable if the anchors adjust the phase of the transmitted signals based on a time difference between the anchors so that the signals of the anchors appear to be transmitted coherently. In a simple embodiment, the anchors transmit their signals at fixed times relative to their respective local timer, which also leads to deviations due to drift in the case of time synchronisation. However, the anchor system may appear from the outside to be non-coherent due to known phase jumps when switching and also due to different phase positions of the radiation of different anchors. This can be changed by slightly altering the switching times so that the anchor system appears coherent from the outside, at least above a certain distance from each anchor. This simplifies the necessary calculations.

With particular advantage for easy installation, the or some of the anchors are part of, in particular fixed, loudspeakers and/or lamps and/or other electrical infrastructures in-stalled or operated in buildings or rooms (also: plug sockets, switches, smoke detectors, etc.).

Advantageously for the accuracy and robustness of the method, the radio node (an object) communicates with the at least two anchors (each also an object) via a plurality of antenna paths and/or the anchors, or abstractly two objects, communicate with each other in pairs via a plurality of antenna paths An antenna path is, in particular, the radio channel from a first transmitting antenna to a first receiving antenna. If, for example, two antennas, e.g. of an object such as an anchor, are used for reception and the signals received there are analysed separately, two antenna paths are used. If a second transmitting antenna, for example of the radio node, is then also used, for example at a later time, and the signals are received with the two receiving antennas, four antenna paths are used.

In certain applications it is preferable to set up an ad hoc anchor network of mobile de-vices and that the anchors in particular first determine information on their relative arrangement and thereby synchronise frequencies and/or times, in particular do this re-peatedly. In this way, a solid anchor network can be set up and a determination carried out quickly; this is possible with active and/or passive radio nodes.

Depending on the application, it is generally preferable to work with active and/or passive radio nodes. Passive radio nodes are advantageous, for example, if a large number of radio nodes are used simultaneously and/or the radio node(s) is/are to remain anony-mous and/or undetected. The use of active radio nodes can be advantageous if they are to consume as little electrical power as possible, i.e. only transmit briefly and do not receive for long periods. The combination of active and passive determinations for a radio node can utilise the advantages of both variants.

The following considerations are helpful for comprehension with regard to the in-line phase return:

On a tone (i.e. a frequency f) the measured phase shift in the receiver (Ph) is:

$$Ph = const + dt * f + s / lambda$$

const is here the phase difference between the two PLLs of objects A and B, where:
dt is the time deviation between the timers of objects A and B—the formula does not take any time drift into consideration
s: Constant distance between the objects
lambda: Wavelength at frequency f

The phase shift (PhA) and (PhB) at the receiving objects A and B is then:

$$P hA = const + dt * f + s / lambda$$

$$PhB = - const + - dt * f + s / lambda$$

The sum of the phase shifts of the two objects A and B is therefore on the same tone:

$$P h A + P hB = const + dt * f + s / lambda - const - dt ⋆ f + s / lambda$$

$$PhA + PhB = 2 * s / lambda$$

This allows the distance s to be determined, in particular preferably with non-negated in-line phase return.

The difference between the phase shifts of the two objects A and B on the same tone (without drift and at a constant distance) is:

$$PhA - PhB = const + dt * f + s / lambda + const + dt ⋆ f + s / lambda$$

$$PhA - PhB = 2 * const + 2 dt * f$$

If the PLL offset (const) is known, the time offset can be determined in this way, in particular with negated in-line phase return, and used in particular for correction. If this is repeated at a different time, the relative drift between the timers, for example, can also be determined.

If the method is carried out, in particular with negated in-line phase return, at two different frequencies, for example a first signal round trip at f1 and a second at f2, and a second-degree phase shift difference is formed, in particular using a negated in-line phase return, the result is:

$$P h A ( f 1 ) - PhB ( f 1 ) - ( P h A ( f 2 ) - P h B ( f 2 ) ) = 2 * const + 2 * dt * f 1 - {2}^{⋆} const - 2 ⋆ dt * f 2$$

$$PhA ( f 1 ) - PhB ( f 1 ) - ( P h A ( f 2 ) - P h B ( f 2 ) ) = 2 * dt * f 1 - 2 * dt * f 2$$

$$PhA ( f 1 ) - PhB ( f 1 ) - ( P h A ( f 2 ) - P h B ( f 2 ) ) = 2 * dt * ( f 1 - f 2 )$$

This can also be expressed as dT=[PhA (f1)−PhB (f1)−(PhA (f2)−PhB (f2))]/2/dF

If the difference in frequencies is known, the time offset can be determined easily and reliably. If the time difference is known, the frequency difference can be determined reliably and easily.

This can be further simplified using a negated inline phase return, since

PhA (f1)−PhB (f1) can be determined directly by measurement (Mf1) at the end of the round trip, as can PhA (f2)−PhB (f2) (=Mf2).

This gives

$$dT = ddPh / 2 / dF$$

where ddPh=Mf1-Mf2 (second-degree phase shift difference)

### BRIEF DESCRIPTION OF THE DRAWINGS

The following explains the inventions purely by way of example using the purely schematic figures. The figures show:

FIG. 1 an example of two possible ways of performing the method,

FIG. 2 an illustration of an anchor network and an active radio node,

FIG. 3 an illustration of an anchor network and a passive radio node, and

FIG. 4 an illustration of a time synchronisation using in-line phase return.

### DETAILED DESCRIPTION

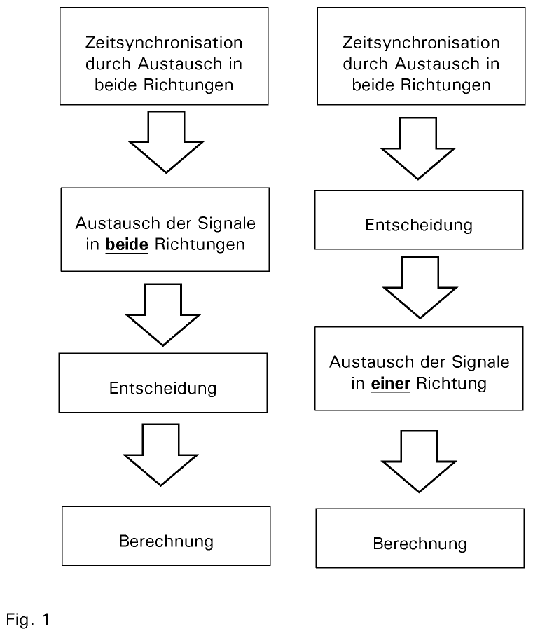

FIG. 1 shows a purely schematic and non-exhaustive example of two possible ways of performing the method. In the left-hand column, the decision is taken only after the signals of the first and second objects have been transmitted, while in the right-hand column the decision is taken before the signals are transmitted and only one of the objects transmits the signals. Common to both methods is that the calculation or determination of the distance considers only the signals of one of the objects.

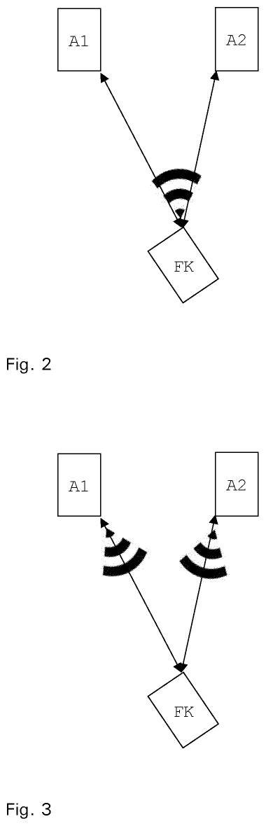

FIG. 2 shows an anchor network with two anchors A1, A2 with fixed position and known distance. The radio node FK transmits unidirectional signals which are received by the anchors A1, A2. These are used to determine the difference between the distances indicated by the double arrows. If the method is carried out with a plurality of anchors, for example three or four, and their positions are known, the position of the radio node can be determined in 2 or 3 dimensions.

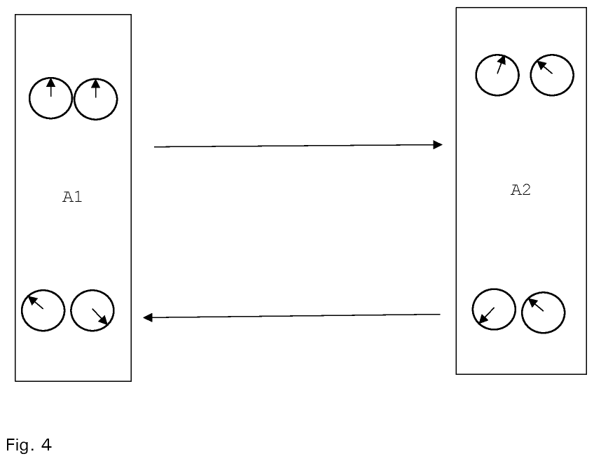

FIG. 3 shows an anchor network with two anchors A1, A2 and a passive radio node FK which receives the unidirectional signals from anchors A1, A2 and determines the difference between the distances indicated by the double arrows. If the method is carried out with a plurality of anchors, for example three or four, and their positions are known, the position of the radio node can be determined in 2 or 3 dimensions.

FIG. 4 shows an illustration of the time synchronisation by means of negated in-line phase return between two objects A1, A2 that can be anchors of an anchor network. The objects each have local timers and a PLL that are preferably set to approximately the same frequencies, the phase position of which is known in relation to the respective local timer of the object, assumed here to be identical for the sake of simplicity, and the phase of which is shown for each anchor at two times Ta, Td for object A1 and Tb, Tc for object A2 by pointers in a circle, the outer circle in each case. The pointers in the in-ner circles (A1 on the right, A2 on the left) indicate the phase of a signal. The arrows between the objects indicate signals, the upper one a first signal from the first object A1 to the second object A2 and the lower one a second signal from the second object A2 to the first object A1. The first object transmits a signal starting at time Ta with the phase position of the internal PLL, therefore the pointers are identical. The start of this signal is received at the second object at time Tb, with a phase position indicated by the upper left pointer, while the internal PLL of the second object A2 has the phase indicated by the upper right pointer. The second object starts to transmit the second signal at time Tc that has been assumed to be roughly equal to Tb for simplified representation. Without in-line phase return, this signal would be transmitted with the phase of the PLL. For the negated in-line phase return, however, it is now rotated by the negated deviation of the received first signal relative to the PLL of the second object and thus transmitted starting with a deviating phase position illustrated by the lower left pointer in the second object. The first object receives the signal and determines the phase position of the start of the signal relative to its own PLL. From this, together with the phase of the start of transmission of the first signal, it can determine the phase shift through the radio channel of the round trip. The start of the signal does not necessarily have to be used as the time reference point.

If the distance is constant and known, the deviation between the timers of the objects can be determined, for example using the formula explained above

$$PhA - PhB = 2 * const + 2 * dt * f$$

If the distance is constant, the deviation between the timers of the objects can be determined by repetition, even if the distance is not known, for example using the formula explained above: dT=ddPh/2/dF

1. A method for determining distances using radio signals or for detecting relay attacks, each having a timer, using radio signals, in which the two objects transmit radio signals on a plurality of frequencies and the radio signals are received by a respective non-transmitting object of the two objects, on which said non-transmitting object which received the radio signal carries out at least one measurement of the phase or at least one measurement of the signal arrival time or the signal delay relative to its own timer per frequency or radio signal and replies to it by transmitting at least one radio signal, with the respective non-transmitting object of the two objects receiving the at least one radio signal transmitted as a reply carrying out at least one measurement of the phase or at least one measurement of the signal arrival time or the signal delay relative to its own timer per frequency or radio signal and from this carrying out at least one determination of the phase shift or at least one determination of the signal delay per frequency; on the basis of the at least one determination, an evaluation is performed, with said method including a determination of a time deviation between the timers of the two objects, said method containing a decision at least for each frequency or signal round trip time as to whether the measurements on the at least one signal of a first object or a second object is to be used for the determination of the distance or detection, with said decision being taken, with the selected measurements being corrected by the influence of the determined time deviation and or the determined drift for the determination of the distance or for the detection.

2. The method according to claim 1, in which at least one difference is determined between each of two phase shifts caused between the two objects by a transmission or by a signal round trip, in which the transmissions or different signal round trips are carried out with signals of different frequency and in which the determination of the distance, the detection of relay attacks or the determination of the time deviation is based on this at least one difference.

3. The method according to claim 1, in which the method is carried out in such a way that, in order to determine the time deviation or drift, the relative phase position of two radio signals of different frequencies by means of the PLL of an object is known in each case as a function of the time difference of the generation or transmission of the two signals at one of the objects relative to its timer, or the phase position of the PLL of each of the objects at different frequencies is known in each case relative to its timer, with the determination of the time deviation or drift between the objects being carried out radio-based by phase measurement(s) on a plurality of the radio signals of different frequencies transmitted between the two objects.

4. The method according to claim 1, in which the time deviation or drift is determined by determining the phase shift of the transmission of the forward path signal from the first object to the second object and the return path signal from the second object to the first object by means of in-line phase return.

5. The method according to claim 4, in which the in-line phase return is preferably effected by changing the phase position of the return path signal relative to a phase position known to the local timer of the second object, by the negated measured phase of the forward path signal received at the second object.

6. The method according to claim 1, in which a plurality of forward and return path signals, are exchanged between the objects.

7. The method according to claim 1, in which the phase position of a second signal received at the first object is determined at the first object and used together with the phase position of a first signal at the first object relative to the PLL of the first object, for time synchronisation.

8. The method according to claim 1, in which the determination of the time deviation or drift, is performed radio-based by means of repeated, unidirectional signal exchange from the first object to the second object, and on the basis of phase measurement(s) on the signal(s) received at the second object, with the phase position of the unidirectional signal of the first object received at the second object being determined.

9. (canceled)

10. The method according to claim 8, in which the relative difference of the phase shifts caused by the transmissions, between the two unidirectional signals at a first frequency and a second frequency measured on received unidirectional signals at the first frequency and the second frequency, i.e. normalised to the difference between the first frequency and second frequency, is used for time synchronisation.

11. The method according to claim 1, in which the determination of the time deviation or drift is performed by determining the phase shift of the transmission of the forward path signal from the first object to the second object and the return path signal from the second object to the first object by means of in-line phase return, by the negated measured phase of the forward path signal received at the second object at the second object.

12. (canceled)

13. (canceled)

14. (canceled)

15. (canceled)

16. (canceled)

17. (canceled)

18. (canceled)

19. The method according to claim 1, in which, if a relay attack is suspected or as an enable decision an access or enable is denied, a requested activity or action is not performed or an alarm or blocking is performed, or if a relay attack is not suspected or as an enable decision the access or enable is granted or the requested activity or action is performed or the alarm or blocking is not performed.

20. (canceled)

21. (canceled)

22. (canceled)

23. (canceled)

24. (canceled)

25. A method for time synchronisation, frequency synchronisation or determination of a time difference or frequency deviation between a first object and a second object, in which the objects each have at least one local timer and at least one PLL in each case, in which the time synchronisation, frequency synchronisation or determination between the first and second objects is carried out radio-based by means of phase measurements on a plurality of signals, of different frequency transmitted between the first and second objects; wherein at least one difference in the phase shifts is caused by the transmission from the first object to the second object and the transmission from the second object to the first object and the time synchronisation, frequency synchronisation or determination is carried out based on the at least one difference.

26. The method according to claim 25 in which the first and second objects transmit radio signals on a plurality of frequencies and the radio signals are received by a respective non-transmitting object of the first and second objects, and a receiving object of the first and second objects performs at least one measurement of the phase relative to its timer for each frequency or radio signal; wherein the respective non-transmitting object of the first and second objects receives the at least one radio signal transmitted as a response and performs at least one measurement of the phase or at least one measurement of the signal arrival time or signal delay relative to its timer for each frequency or radio signal.

27. The method according to claim 25 in which at least one second-degree difference is determined in each case between two of the at least one difference between the phase shifts caused by the transmission from the first object to the second object and the phase shifts caused by the transmission from the second object to the first object in each case of a signal round trip between the first and second objects, wherein in each case the transmissions of a signal round trip from the first object to the second object and from the second object to the first object are carried out with frequency and the transmissions of different signal round trips are carried out with different frequencies between the signal round trips and wherein the distance determination, the time synchronisation, frequency synchronisation or determination is based on this at least one second-degree difference.

28. The method according to claim 25 in which the time synchronisation or determination of the time difference is performed by determining the phase shift of the transmission of the forward path signal from the first object to the second object and the return path signal from the second object to the first object by in-line phase return.

29. (canceled)

30. (canceled)

31. (canceled)

32. (canceled)

33. (canceled)

34. The method according to claim 25 in which the relative second-degree difference, i.e. the difference normalised to the difference between a first frequency and a second frequency, measured on received unidirectional signals at the first frequency and the second frequency of the phase shifts caused by the transmissions between the two unidirectional signals at the first and second frequencies is used for time synchronisation.

35. The method according to claim in which the time synchronisation, frequency synchronisation or determination of the frequency or time deviation is performed by determining the phase shift of the transmission of the forward path signal from the first object to the second object and the return path signal from the second object to the first object by means of in-line phase return by the negated measured phase of the forward path signal received at the second object at the second object.

36. (canceled)

37. (canceled)

38. (canceled)

39. (canceled)

40. (canceled)

41. (canceled)

42. The method according to claim 25 in which at least one second-degree difference is determined between the differences between two phase shifts between the first and second objects which are each caused by a signal round trip, signal round trips are carried out with signals between the signal round trips of different frequency and in which the distance determination, time synchronisation, frequency synchronisation or determination is based on this at least one second-degree difference.

43. The method according to claim 25 in which the at least one difference is determined between each of two phase shifts caused by a transmission between the first and second objects, in which the transmissions are performed with signals of different frequency, and in which the distance determination, time synchronisation, frequency synchronisation or determination is based on said at least one difference.

44. An object, having a timer, said object being designed to transmit radio signals on a plurality of frequencies and to receive radio signals from other objects and to carry out at least one measurement of the phase or at least one measurement of the signal arrival time or the signal delay relative to its timer on the received radio signals for each frequency or radio signal and designed for carrying out a method according to claim 25 together with a further object.

45. A system having at least two objects according to claim 1, said system being designed to carry out a method according to claim 1.
